(19) United States
(12) Patent Application Publication
(10) Pub. No.: US 2008/0031718 A1
(43) Pub. Date: Feb. 7, 2008

(54) Maneuverability assister

(76) Inventors: Myron Ross, Spicewood, TX (US); Deborah Ross, Spicewood, TX (US); Olivia Cribbs, Marble Falls, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 11/242,440

(22) Filed: Oct. 3, 2005

(51) Int. Cl. B27B 31/04

(52) U.S. Cl. 414/781

(57) ABSTRACT

A system for assisting a physically challenged person, for example, a less mobile person in a wheelchair, assists in maneuvering the person and wheelchair. The system includes a frame, a wheel connected to the frame, a rack formed to glide on the frame, and a support connected to the rack. The support is formed to accommodate wheels of a wheelchair and a person sitting in the wheelchair. A mechanized lifter is connected to the rack and the frame, and the lifter selectively vertically raises and lowers the rack along the frame. A mechanized recliner is connected to the rack and the support, and the recliner selectively tilts forward and backwards the support relative the frame. By loading the wheelchair and person onto the support of the system, the wheelchair and person can be moved laterally, vertically, and reclined, by movement of the system and the support of the system. The person in the wheelchair can remain seated in the wheelchair to obtain the movement assistance. The system can be employed in a beauty salon.

### BACKGROUND OF THE INVENTION

The present invention generally relates to systems to aid in moving and maneuvering persons desiring assistance and, more particularly, relates to wheelchair lift, movement, and reclining assister devices.

Conventionally, less mobile persons, for example, certain persons in wheelchairs and the like, must at times be manually lifted, moved, and reclined, either by the person's own efforts or through the assistance of other persons. Chairs are, of course, generally stationary. Wheelchairs allow certain directional movement along a floor, however, they do not typically include any features for significantly raising/lowering or reclining.

This presents disadvantages in certain instances, for example, in beauty treatments, medical examinations, and other instances generally requiring greater level of maneuverability of persons. Less-mobile or physically challenged persons, or those desiring assistance in movement, at times can be relatively heavy and may be supported by one or more human assisters capable of heavy lifting and other similar support and assistance abilities. Where there is not any able assister, or those assisting do not have sufficient ability and strength, persons may not be readily or easily moveable. Even in instances in which able persons can provide assistance, there are concerns about safety, falls, adequacy and others.

A particular situation of a beauty salon that caters to many different people, including persons who may benefit from assistance, is an example where added assistance availability is desirable. For example, a person in a wheelchair who is less mobile or desiring assistance with movement, is at times not easily or readily liftable, maneuverable, or reclinable. In this setting, a stylist or other beauty professional can have troubles in accessing the client where the client is located too low or not reclining. Stylists typically prefer that the client's head be situated at a height suitable for the stylist to work with the hair and other features. Also, stylists often wish to be able to wash hair in sinks made for reclined washing. In these and other similar scenarios, mechanical or other assister mechanisms or facilities have not been available or known.

It would, therefore, be a significant improvement in the art and technology to provide assistance mechanisms and facilities more readily adaptable to scenarios like those mentioned and also other scenarios. The present invention provides numerous advantages and improvements, including improvements and nuances in the foregoing respects.

### SUMMARY OF THE INVENTION

An embodiment of the invention is a system for assisting maneuvering. The system includes a frame, a wheel connected to the frame, a rack formed to glide on the frame, and a support connected to the rack.

Another embodiment of the invention is a system for assisting maneuvering. The system includes a frame, a wheel connected to the frame, and a support pivotally connected to the frame.

Yet another embodiment of the invention is a system for manipulating a load. The system includes a load support and a jack connected to the support, for vertically moving the support and for reclining the support.

Another embodiment of the invention is a method of assisting maneuverability of a person in a wheelchair. The method includes lifting the wheelchair and the person in the wheelchair and reclining the wheelchair and the person in the wheelchair.

Yet another embodiment of the invention is a method of assisting a load. The method includes supporting the load via a support, rolling the support, lifting the support, and reclining the support. The rolling, lifting and reclining manipulate the load to roll, lift and recline.

### BRIEF DESCRIPTION OF THE DRAWINGS

The present invention is illustrated by way of example and not limitation in the accompanying figures, in which like references indicate similar elements, and in which:

FIG. 1 illustrates a back perspective view of a system for assisting, having a support for an item, such as a wheelchair, in a reclined position of operation, according to certain embodiments of the invention;

FIG. 2 illustrates a front perspective view of the system for assisting of FIG. 1, further showing a front view of the support of the system in reclined position of operation, according to certain embodiments of the invention;

FIG. 3 illustrates a back side view of the system for assisting of FIGS. 1 and 2, having the support positioned in erect operation with underarms of the support substantially flush with an underlying floor and perpendicular arms of the support substantially vertically positioned, such as the system is operated for loading of an item on the support, according to certain embodiments of the invention

FIG. 4 illustrates a right side view of the system of FIGS. 1-3, having the support positioned as in FIG. 3 such as during loading operations, according to certain embodiments of the invention;

FIG. 5 illustrates a left side view of the system of FIGS. 1-4, having the support positioned as in FIGS. 3-4, according to certain embodiments of the invention;

FIG. 6 illustrates a cutaway side view of a lift jack, one of which serves as a lifter of the support and another of which serves as a recliner of the support, showing internal gear elements that enable contraction and extension of the lift jack in order to provide lifting and reclining operations to the system thereby, according to certain embodiments of the invention;

FIG. 7 illustrates a right side view of a frame of the system of FIGS. 1-5, according to certain embodiments of the invention;

FIG. 8 illustrates a back side view of the frame of the system of FIGS. 1-5 and 7, according to certain embodiments of the invention;

FIG. 9 illustrates a back side view of a rack of the system of FIGS. 1-5, which rack includes tubing guides that fit uprights of the frame of FIGS. 7-8 and is moveable vertically up and down the uprights as guided thereby, according to certain embodiments of the invention;

FIG. 10 illustrates a right side view of the rack of FIGS. 1-5 and 9, according to certain embodiments of the invention;

FIG. 11 illustrates a top side view of the rack of FIGS. 1-5 and 9-10, according to certain embodiments of the invention;

FIG. 12 illustrates a back side view of the frame of FIGS. 7-8, with the rack of FIGS. 9-11 fitted on the uprights of the frame as guides for the rack, providing vertical up and down sliding movement of the rack on the frame in the system of FIGS. 1-5, according to certain embodiments of the invention;

FIG. 13 illustrates a rights side view of a support of the system of FIGS. 1-5, the support providing a load handling and support element for the system, wherein a wheelchair or the like can be loaded on underarms of the support and retained against perpendicular arms of the support, and the support is raised/lowered and reclined/erected during operations of the system, according to certain embodiments of the invention;

FIG. 14 illustrates a top side view of the support of FIG. 13, viewed looking down onto the underarms as a load handling surface of the support, according to certain embodiments of the invention; and

FIG. 15 illustrates front side view of the support of FIGS. 13-14, viewed looking back into the face side of the perpendicular arms of the support, according to certain embodiments of the invention.

### DETAILED DESCRIPTION

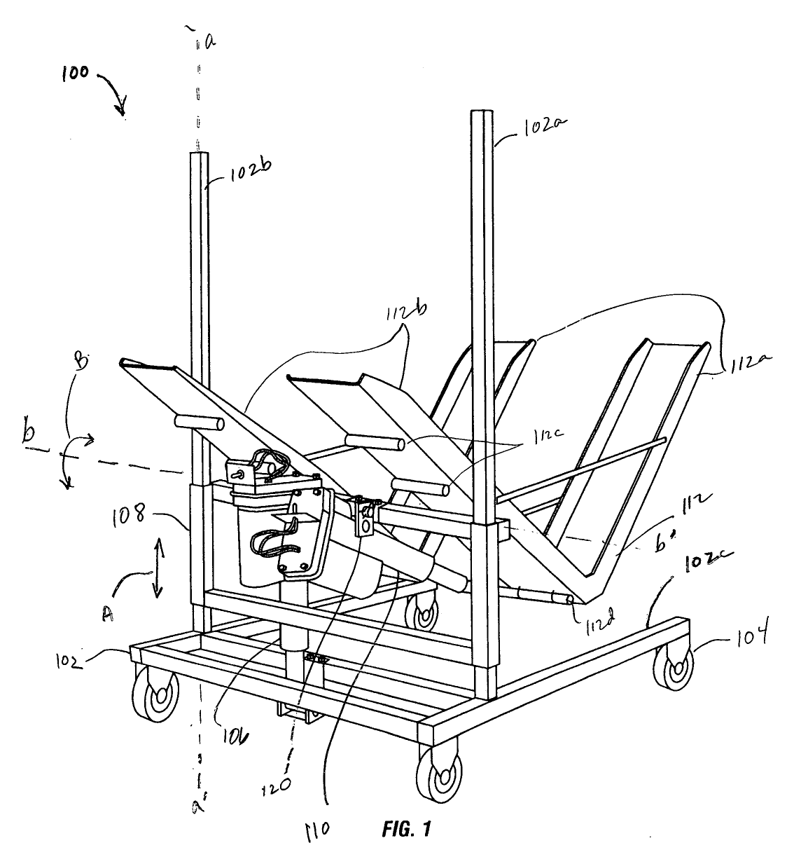

Referring to FIG. 1, an assister system 100 includes a frame 102 mounted with connected wheels 104. Uprights 102a of the frame 102 extend upright, substantially vertically and perpendicular to a surface, such as a floor, on which the frame 102 rests via the wheels 104. A lifter jack 106 is connected to the frame 102.

The lifter jack 106 is also connected to a guidable rack 108. The rack 108 is moveably connected to the uprights 102a, for example, in a slidable manner along the uprights 102. The rack 108 is so guided to move vertically up and down with respect to a surface underlying the frame 102, via the uprights 102a of the frame 102 and extension and retraction of the lifter jack 106.

The rack 108 of the system 100 is also connected to a recliner jack 110. A support 112 is pivotally connected to the rack 108. The recliner jack 110 is also connected to the support 112.

The support 112 accommodates an item (not shown in FIG. 1) to be maneuvered via the system 100, such as a wheelchair, a chair or seat, a device, a person, or other thing as applicable and desired for the application. The support 112 has under arms 112a and perpendicular arms 112b, each of the arms 112a or 112b connected to and forming an angle with respect to the other of the arms 112b or 112a. The angle may be, for example, about 90° degrees.

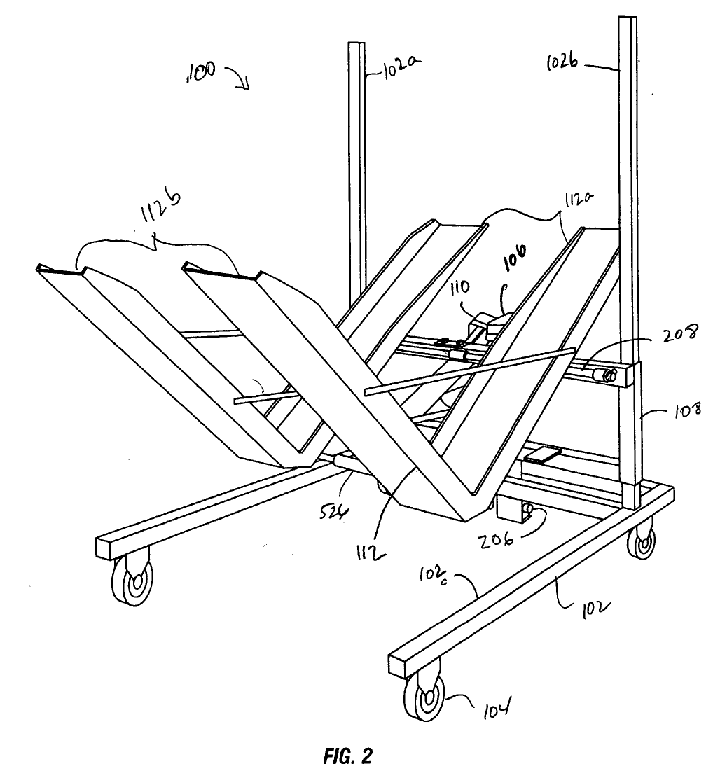

The perpendicular arms 112b of the support 112 include one or more guides 112c on a surface or side of the perpendicular arms 112b adjacent the rack 108 of the system 100. These guides are pivot points for pivotal connection to the rack 108. As later shown in certain figures, the rack 108 includes a connected pivot rod (not shown in FIG. 1, but shown in FIG. 2). This pivot rod fits through the guides 112c, and the support 112 can recline as illustrated by arrow A and axis a-a′ formed by a lateral portion of the rack 108 extending between the supporting uprights 102a.

The support 112 is suitable for accommodating wheels of a wheelchair or the like in under arms 112a of the support 112 that form channels (or other suitable receiving and retaining surfaces). The support 112 also includes perpendicular arms 112b that form approximately right angles with respect to the under arms 112a. These perpendicular arms 112b can also formed as channels similar to the under arms 112a, or alternately could be any other type of surface that can support an item loaded on the system 100 (i.e., when the support 112 is reclined, as hereafter more fully described, causing a side of the item to rest against the perpendicular arms 112b or otherwise be restrained from sliding from the under arms 112a when the support 112 is reclined).

In operation, the frame 102 sits, via a base 102c of the frame 102 and the wheels 104 connected to the base 102c, on a surface, such as a floor. The uprights 102a of the frame 102 extend upwardly relative to the surface from the base of the frame 102. The rack 108 is fitted to glide along and move vertically up and down on the uprights 102a. The lifter jack 106, connected to the rack 108 and the frame 102, moves the rack 108 with respect to the frame 102 along the uprights 102a, to position the rack 108 vertically with respect to the base of the frame 102 and the floor or other surface. The support 112, as pivotally attached to the rack 108 and the recliner jack 110, is pivotally moved with respect to the rack 108, by the recliner jack 110 connected to the rack 108 and the support 112. The recliner jack 110 tilts the support 112 from relatively vertical and horizontal position for the perpendicular arms 112b and under arms 112a, respectively.

The wheels 104 permit ease of lateral movement of the system 100 across a surface on which the system 100 sits, for example, a floor, platform or other somewhat planar surface. An item, such as a wheelchair, is moved into position on the support 112. For example, the support 112 in FIG. 1 is formed with dual under arms 112a forming channels with sides. The under arms 112a are lowered to sit directly on top of the floor or other surface, so that a wheelchair or the like can be pulled when backing the wheelchair onto the under arms 112a and the system 100 (and/or pushed into position) with wheels of the wheelchair in the channels of the under arms 112a.

The angular orientation of the under arms 112a to parallel with the floor or other surface is achieved by operating the recliner jack 110 to pivot the support 112 such that the under arms 112a reside parallel with floor or surface. The vertical orientation of the under arms 112a of the support 112 to sit atop and substantially flush with the floor or surface is achieved by the operating the lifter jack 106 to downwardly move the rack 108 on the uprights 102a of the frame 102, thus downwardly moving the support 112 pivotally connected on the rack 108 until the under arms 112a sit on and rest substantially flush on the floor or surface. The wheelchair or other similar item is then manually pulled, or otherwise moved or manipulated, for example, via the wheelchair's wheels and a person sitting in the wheelchair, to position the wheelchair wheels on and within the sides of the under arms 112a along the track of those wheels.

When the wheelchair or other similar item is positioned on the support 112 in this manner, the wheelchair is locked via its wheel locking mechanism and/or other features of the system 100 for safety (not shown, but described later in somewhat detail and otherwise as available or desired). The system 100 then (by manual or automated operation of the system 100, as applicable, and also as later more described) manipulates the wheelchair upward and downward, laterally across the floor or surface, and in recline with respect to the vertical uprights and the underlying floor or surface.

Such manipulation of the item loaded on the under arms 112a of the system 100 can be by movement of the entire system 100 (with item thereon) across the underlying floor or surface. The movement of the system 100 across the floor can be manual or automated. Generally, the under arms 112a are raised, at least slightly if not more, off the rest atop the floor, in the manner of lifting previously mentioned. Also, it can be helpful or desired to slightly recline the support with respect to vertical, such that the under arms 112a of the support 112 are angled downward towards the perpendicular arms 112b, to retain the item against the perpendicular arms 112b of the support 112. Then, the system 100 is located to the desired place for the system 100, either by a powered drive (not shown) that causes the system 100 to move on the wheels 104 to a desired location, manually by a human assistant, or otherwise. The system 100 is thereby moveable along the floor in lateral directions, both when a wheelchair or other item is positioned on the support 112 and when one is not.

The manipulation of the item loaded on the under arms 112a of the system 100 can also be by vertical up and down movement of the rack 108 and support 112 pivotally connected thereto. The lifter jack 106 mechanically positions the rack 108 in a vertical position as the rack 108 is guided by the uprights 102b. The lifter jack 106 provides a range of movement of the rack 108 and support 112 thereto, from about a position wherein the under arms 112a are flush with the floor and vertically upward to about a position wherein the rack 108 and support 112 are located vertically higher. Arrow A in FIG. 1 illustrates the vertical movement (for example, on the order of about >0″ up to about 14″ or greater in the directions along phantom axis a-a′) of the support 112 capable with the system 100. The lifter jack 106 is sufficient to mechanically and automatedly, for example, by switching on/off a motor or other mechanism of the lifter jack 106, raise the rack 108 and thereby the support 112 when an item is or is not loaded on the support 112. For example, if a wheelchair and a person in the wheelchair is loaded on the support 112, the lifter jack 106 is capable of lifting the wheelchair and person together via the positioning of the wheelchair on the support 112.

Manipulation of the item loaded on the under arms 112a of the system 100 can also be by recline of the support 112. The recliner jack 110 is pivotally attached to the rack 108 and also pivotally attached to the support 112, such as at the intersection of the under arms 112a and the perpendicular arms 112b of the support 112. The recliner jack 110 mechanically positions the support 112 in a recline position, for example, such that the range of movement of the support 112 can be from about a position where the under arms 112a are substantially horizontal and the perpendicular arms 112b are substantially vertical, to about a position where the under arms 112a are nearing vertical and the perpendicular arms 112b are nearing horizontal. Arrow B in FIG. 1 illustrates the reclining movement (for example, about ¼ reciprocation around phantom axis b-b′) of the support 112 capable with the system 100. The recliner jack 110 is sufficient to mechanically and automatedly, for example, by switching on/off a motor or other mechanism of the recliner jack 110, tilt and recline the support 112 when an item is or is not loaded on the support 112.

For example, an item loaded on the support 112 can be reclined from a normal position of the item when resting on a floor or surface, to a leaned-back position with respect to the normal position on the floor. Where the item is a wheelchair, the wheelchair, backed onto position on the under arms 112a of the support 112, is reclined when the recliner jack 110 is operated to tilt the support 112. As with the lifting operations of the system 100, the recliner jack 110 and reclining operations are capable of reclining the wheelchair and a person in the wheelchair together, via positioning of the support 112 in a reclined attitude with the wheelchair on the support 112.

The system 100 is employed, for example, to assist a wheelchair-situated person to be more easily and mechanically maneuvered to lean back, lean forward, lift up, lower down, and from side to side. Because the wheelchair and person therein are moved as a unit by the system 100, the person need not be particularly maneuvered or manipulated from the seat in the wheelchair. The system 100 is particularly suited for assisting a customer in a wheelchair at a beauty shop, salon, dental or medical office, and any of a wide variety of other situations.

In the instance of use of the system 100 in a beauty shop or salon, a wheelchair and person seated on the wheelchair are moved, via the wheelchair wheels, onto the under arms 112a of the support 112. As needed, the support is lowered so that the under arms 112a are substantially flush with the floor, to make movement of the wheelchair onto the support 112 easy. Then, the support 112 is raised via the lifter jack 106. If and as desired, the support 112 is reclined via the recliner jack 110. For example, once the system 100 is loaded with the person and wheelchair, it may be desired to move the system 100 as loaded to another area, such as near a hair washing sink as conventional in many beauty shops. The system 100 is backed up to the sink, and then the support 112 is further reclined, so that the person in the wheelchair can rest his head on the sink for washing, in typical manner. After washing, the support 112 can be moved back for less recline, and the support 112 can be lifted to a height desired for the beauty stylist to more easily treat the person's hair. Of course, various lifting, reclining, and lateral moving operations by the system 100 can be combined at any point in order to position the loaded wheelchair and person on the system 100 as desired.

Referring to FIG. 2, the system 100 includes a pivot rod 208 (as previously mentioned, but not shown in FIG. 1) of the rack 108. The pivot rod 208 is connected to the rack 108 to allow clearance so that the support 112 can pivot on the rod 208. In particular, the pivot rod 208 provides clearance sufficient for the guides 112c of the support 112 to freely pivot for reclining operations of the support 112. The guides 112c are located at desired distances or increments of the perpendicular arms 112b. Matching guides 112c of each arm 112b fit the pivot rod 208 for the pivoting movement. (In certain embodiments, although not required but shown for example purposes in FIGS. 1 and 2, multiple corresponding sets of the guides 112c can be fixed to the perpendicular arms 112b of the support 112 to permit selection among the sets of the guides 112c to vary vertical movement capabilities provided by the lifter.)

Referring back to FIG. 1, in conjunction with FIG. 2, the recliner jack 110 is similar connected to the rack 108 in a manner to allow pivot of the recliner jack 110 where connected to the rack 108. A bracket 120 includes a pin or other mechanism to connect the recliner jack 110 to the rack 108. The recliner jack 110 extends and contracts, by mechanical operations, between the connection of the recliner jack 110 to the support 112 and the connection of the recliner jack 110 to the rack 108. The recliner jack 110 thereby can automatedly tilt and recline the support 112, as desired and operated by switching or other on/off or similar mechanism of the recliner jack 110.

Continuing to refer to FIG. 2, the lifter jack 106 is connected to the rack 108 and also to the frame 102 via a bracket 206. The connection of the lifter jack 106 to the rack 108 and to the frame 102 by the bracket 206 also each include pins or other mechanisms for connecting the lifter jack 106 thereto. The lifter jack 106 extends and contracts, by mechanical operations, between the connection of the lifter jack 106 to the rack 108 and the connection to the frame 102. The lifter jack 106 thereby automatedly lifts and lowers the support 112, as desired and operated by switching or other on/off or similar mechanism.

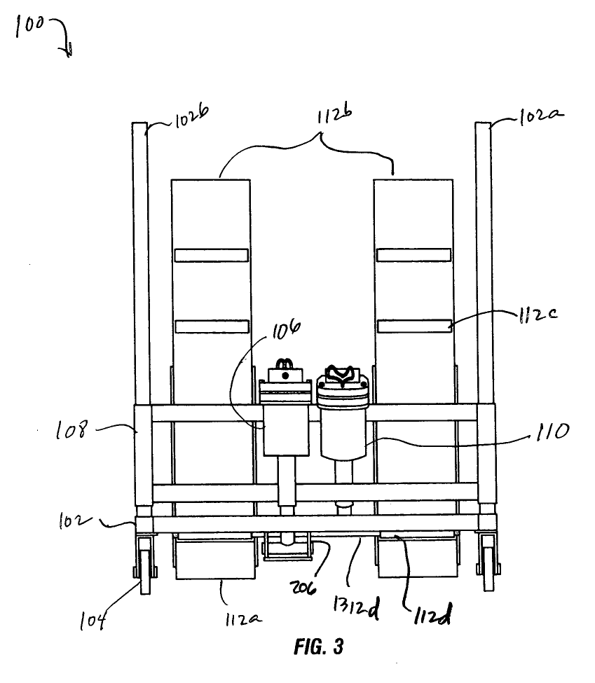

Referring to FIG. 3, the system 100 is positioned such that the support 112 has its under arms 112a substantially flush with the underlying floor on which the system 100 sits. This position of the support 112 permits loading of an item on the support 112, such as a wheelchair or other rolling item that can be pushed/pulled into location on the under arms 112a. The lifter jack 106 of the system 100 is connected to the rack 108 and the frame 102, and the recliner jack 110 is connected to the rack 108 and the support 112. The rack 108 is seen as guided in vertical movement from the lifter jack 106 by the uprights 102a, 102b. As so guided, the rack 108 is substantially stationary in lateral movement but guided to permit vertical movement by the uprights 102a, 102b. Each of the lifter jack 106 and the recliner jack 110 are pivotally connected to the rack 108 so that they move with the rack 108 as it is raised and lowered. The lifter jack 106 is also pivotally connected to the frame 102 by pivot pin and bracket. In addition to pivotal connection to the rack 108, the recliner jack 110 is connected to the support 112 via matched guides 112c located generally in the vicinity of and near the perpendicular arms 112b where the arms 112b join to the under arms 112a. The frame 102 and entire system 100 is supported on the floor by the wheels 104.

Referring to FIG. 4, the system 100 is positioned such that under arms 112a of the support 112 are substantially flush with the floor, as in FIG. 3. The upright 102b of the frame 102 guides the rack 108 formed to glide vertically up and down along the upright 102b, as mechanically moved by the lifter jack 106 (as does the upright 102a but hidden from view in FIG. 4). The lifter jack 106 is positioned to substantially vertically extend and contract between the lifter jack 106 connection to the rack 108, on an upper end in FIG. 4, and to the frame 102 at a bracket 206 of the frame 102, on a lower end in FIG. 4.

By extension and contraction of the lifter jack 106 mechanisms, the lifter jack 106 raises and lowers the rack 108 vertically along the guide provided by the upright 102b therefor. The rack 108 is pivotally connected to the perpendicular arms 112b of the support 112 along the underside thereof some distance from the intersection of the perpendicular arms 112b and the under arms 112a. The pivotal connection is made via the guides 112c. (As previously mentioned, several guides 112c (forming matching sets on each of the perpendicular arms 112b and 112a) are, in certain embodiments, positioned on the underside of the perpendicular arms 112b, allowing varying adjustments for a wider range of possible vertical and reclining movements of the support 112 (according to the desired uses, configurations, extent of lifting and reclining, materials and lifting and reclining mechanisms, and the like).

The recliner jack 110 (located, in part, behind the lifter jack 106 in FIG. 4) is positioned to substantially extend and contract between the recliner jack 110 where pivotally connected to the rack 108 (adjacent the connection of the lifter jack 106 to the rack 108), on an upper end of FIG. 4, and where pivotally connected to the support 112 at about the intersection of the upper arms 112b and the under arms 112a at a lower guide 112d. By extension of the recliner jack 110 mechanism, the support 112 is rotated (clockwise in FIG. 4, illustrated by arrow C) about the guide 112c where the support 112 is pivotally connected to the rack 108. By contraction of the recliner jack 110 mechanism, the support is rotated (counter-clockwise in FIG. 4) about the guide 112c where the support 112 pivotally connects to the rack 108.

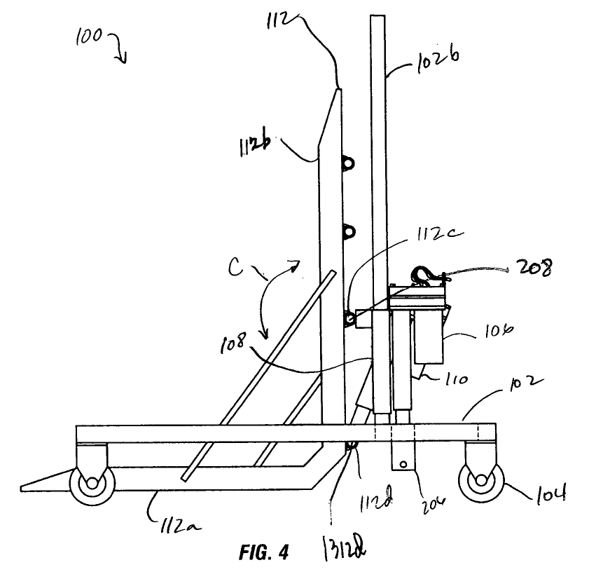

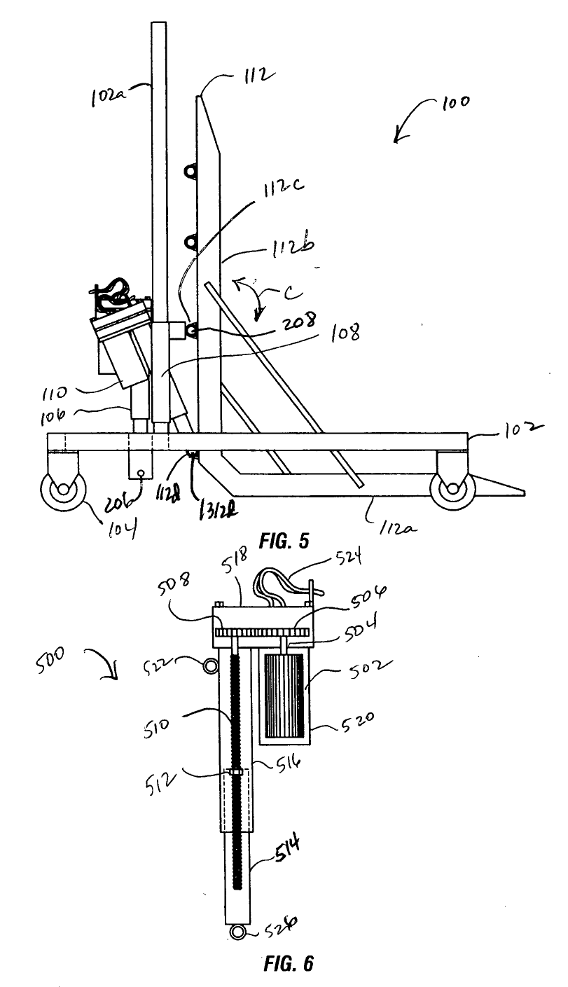

Referring to FIG. 5, the system 100 is positioned as in FIG. 4, such that the under arms 112a of the support 112 are substantially flush with the floor. The upright 102a of the frame 102 guides the rack 108 vertically up and down along the upright 102a. The lifter jack 106 (located, in part, behind the recliner jack 110 in FIG. 5), mechanically moves the rack 108 by extension and contraction of the lifter jack 106. The recliner jack 110 mechanically, by extension and contraction, moves the support 112 pivotally at the guide 112c. As the recliner jack 110 extends, the under arms 112a raise and the upper arms 112b lean back. As the recliner jack 110 contracts (FIG. 5 shows the recliner jack 110 in such contracted operation), the under arms 112a lower to flush or planar with the floor and the upper arms 112b move toward vertical (as shown in FIG. 5). In this manner, the recliner jack 110 operations can respectively lean and rectify the support 112, by pivot rotation around the guide 112c via extension or contraction of the recliner jack 110 between the guide 112c and the lower guide 112d to recline the support 112, and the lifter jack 106 operations can respectively vertically raise and lower the rack 108 via extension or contraction of the lifter jack 106 between the connection at an upper end of the rack 108 (in proximity to the guides 112c) and the connection at the lower guide 206.

Referring to FIG. 6, a lift jack 500 serves as each of the lifter jack 106 and the recliner jack 110, respectively. The lift jack 500 is shown to illustrate, in phantom, the internal elements of the lifter jack 106 and the recliner jack 110. The lift jack 500 includes an electric motor 502. The electric motor 502 includes a drive shaft 504 connected to a first gear 506. The first gear 506 engages with a second gear 508, that has corresponding teeth for movement with and by engaging connection of the first gear 506 and the second gear 508.

A threaded screw 510 is connected to the second gear 508, such that rotation of the second gear 508 turns the screw 510. A nut 512 connects to the screw 510 and can move along the screw 510 by virtue of mating threads. Whenever the screw 510 is turned, the screw 510 turns in the nut 512, and the nut 512 is moved along and in relation to the screw 510.

A housing of the lift jack 500 includes a lower portion 514. The lower portion 514 is, for example, a generally extended cylindrical enclosure having the nut 512 secured at an upper end of the lower portion 514. The screw 510 extends through the nut 512 and into the lower portion 514. As the screw 510 turns in the nut 512, the entire lower portion 514 moves in relation to the screw 510 and the screw 510 extends into and out of the lower portion 514, accordingly. For example, as the screw 510 turns clockwise, the screw 510 extends further into the lower portion 514 and, as the screw 510 turns counter-clockwise, the screw 510 is turned out of the nut 512 and from the lower portion 514. The lower portion 514, at about an opposing lower end of the lower portion 514, is connected to or formed with a guide 526. The guide 526 connects to the frame 102 (in the case of the lift jack 500 operating as the lifter jack 106) at the bracket 206. In the case of the recliner jack 110 (which can be the same or another lift jack 500 or the like), the guide 526 connects to the support 112 at the bracket 206. The guide 526 accepts a pin therethrough, and the pin retains the lift jack 500 in connection with the frame 102 at the bracket 206 (in the case of the lifter jack 106) and the support 112 at the lower guide 112d (in the case of the recliner jack 110), for pivotal securement at the respective guides 526 of the lifter and recliner.

An upper portion 516 also comprises the housing of the lift jack 500. The upper portion 516 is, for example, a generally extended cylinder with an internal diameter and open lower end, each sufficient to accept the lower portion 514 in concentric relation and sliding connection. The screw 510 extends through the upper portion 516, then through the nut 512 and into the lower portion 514. The screw 510 is fixed longitudinally within the upper portion 516.

The upper portion 516 is connected to a gear box 518 of the housing of the lift jack 500. The gear box 518 encloses the first and second gears 506, 508, and retains the gears therein, such that the gears 506, 508 can rotate therein. The screw 510 is connected to the second gear 508, so that rotation of the gear 508 turns the screw 510. The gear box 518 is fixedly connected to the upper portion 516. The upper portion 516 has, at about an upper extension of the portion 516, a second guide 522, connected to or formed therewith. The second guide 522 connects to the rack 108 (in the case of the lift jack 500 operating as the lifter jack 106 and/or the recliner jack 110). The second guide 522 accepts a pin therethrough, and the pin retains the lift jack 500 in connection with the rack 108 (in the case of each of the lifter jack 106 and the recliner jack 110).

Within the gear box 518 the first gear 506 and the second gear 508 are in mated connection. The drive shaft 504 of the motor 520 and connected to the first gear 506, extends out of the gear box 518. The drive shaft 504 of the motor 520 and the motor are enclosed in a motor box 520 fixedly connected to the gear box 518.

Additionally, the housing of the lift jack 500 includes openings for power wires 524 that connect to at least one switch (not shown in FIG. 5). The power wires 524, for example, extend through the gear box 508 and motor box 520, and there connect with the motor 502. The power wires 524 also connect to a power supply (not shown) for powering the motor 502. The motor 502 is switchable, at least three-way, to operate to turn the drive shaft on clockwise or on counterclockwise, or off.

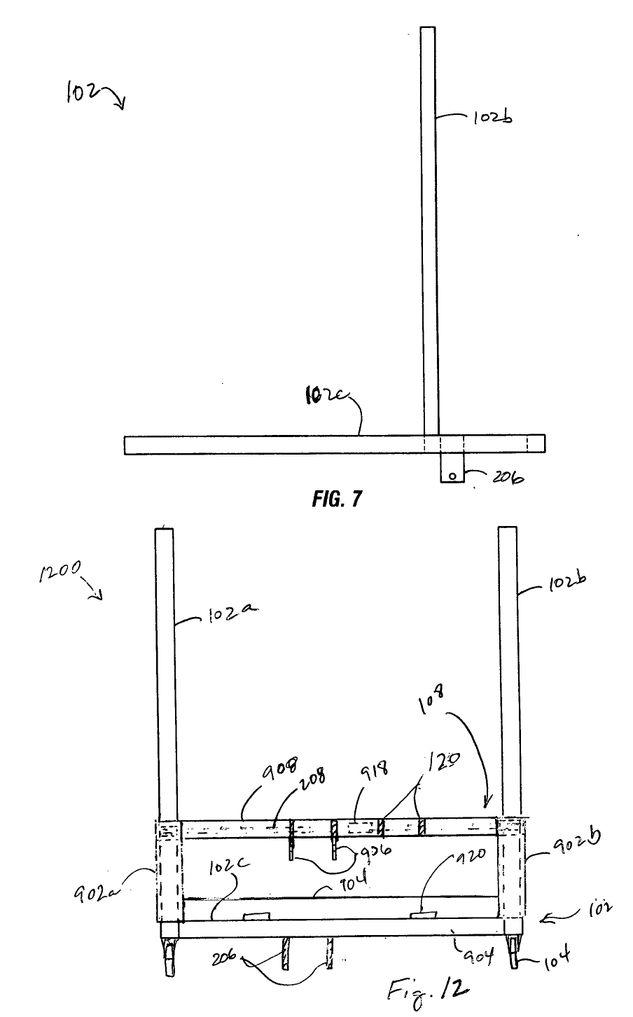

Referring to FIG. 7, the frame 102 includes a lower planar piece 102c and the connected upright 102b. The lower planar piece 102c serves to accommodate brackets and the wheels 104 (shown in FIG. 1) thereon. The upright 102b, and the corresponding upright 102a (not shown in FIG. 7, but behind the upright 102b in FIG. 7), serve to accommodate the rack 108 (shown in FIG. 1) for vertical guided and sliding engagement thereon. The bracket 206 connected to the frame 102 serves to connect to and pivotally engage the lower end of the lift jack 500 that is the lifter jack 106. As mentioned, the bracket 206 connects to the lifter jack 106 via the guide 526 (shown in FIG. 6) of the lifter jack 106, and the pin retains the lifter jack 106 in connected relation to the frame 102.

Referring to FIG. 8, the frame 102 includes the lower planar piece 102c, connected to the uprights 102a, 102b. The bracket 206 is connected to the lower planar piece 102c. The location of the bracket 206 on the lower planar piece 102c can be offset from a middle of the lower planar piece 102c, in order to accommodate positioning of the lift jack 500 that is the lifter jack 106. Adequate room of the frame 102 is required also to accommodate positioning of the other lift jack 500 that is the recliner jack 110.

Referring to FIG. 9, the rack 108 is formed with side tubings 902a, 902b that accept and vertically glide in connected engagement with the respective uprights 102a, 102b (shown in FIG. 8) of the frame 102. The rack 108 includes a bottom brace 904 and a top brace 908, each connected to the tubings 902a, 902b. A lift bracket 906 is connected to and formed with the top brace 908, in a vertically corresponding position to the location of the bracket 206 on the lower planar piece 102c of the frame 102 (shown in FIG. 8, when the rack 108 is positioned on and to vertically glide along the uprights 102a, 102b of the frame 102. The lift bracket 906 connected to the top brace 908 serves to connect to and engage an upper end of the lift jack 500 that is the lifter jack 106 (shown in FIG. 1). As mentioned, the bracket 906 connects to the lifter jack 106 via the guide 522 (shown in FIG. 5) of the lifter jack 106, and a pin retains the lifter jack 106 in connected relation to the frame 102 at the bracket 906.

A recline bracket 120 (also shown in FIG. 1) is also connected to and formed with the top brace 908. The recline bracket 120 is laterally displaced along the top brace 908 from the location of the bracket 906. The recline bracket 120 connected to the top brace 908 serves to connect to and pivotally engage an upper end of the lift jack 500 that is the recliner jack 110 (shown in FIG. 1). The recline bracket 120 connects to the recliner jack 110 via the guide 522 (shown in FIG. 5) of the recliner jack 110. A pin retains the recliner jack 110 in pivotal and connected relation to the frame 102 at the bracket 120.

The top brace 908 is also connected to one or more holder brackets 918. The holder brackets 918 are disposed opposite to the connections for the lifter jack 106 and the recliner jack 110 (i.e., via the brackets 906, 120). As previously mentioned and as shown in other Figures, including, for example, FIGS. 2, 4 and 5, the holder brackets 918 accommodate and fixedly retain a pivot rod 208 (not shown in FIG. 9, but shown in FIG. 2) with a small space from flush with the rack 108. The pivot rod 208 pivotally retains the support 112 to the rack 108, via the guides 112c of the rack 108. The holder brackets 918 fasten the rack 108 to the support 112 via the pivot rod 208. The small space between the pivot rod 208 from flush with the rack 108 is sufficient to permit the guides 112c to pivot freely on the pivot rod 208, yet maintain close association with the top brace 908 of the rack 108.

The rack 108 (or the support 102 or other frame or structure portions) can additionally include various rest stops 920 and the like, in order to support the rack 108 in desired lowest position (or otherwise), to rest the rack 108 movement in desired range and direction, for cushioning of the rack 108 in engagement with the frame 102 or other portions of the system 100, and/or otherwise.

Referring to FIG. 10, the rack 108 includes the top brace 908 and bottom brace 904, connecting the side tubing 902b (and the other side tubing 902a, behind the side tubing 902b in the Figure). On a side of the rack 108, the lift bracket 906 and recline bracket 120 protrude. The recline bracket 120 is formed with a hole that is a distance from the rack 108 (from a vertical side, to the right in FIG. 10), in order to permit the recliner jack 110 to freely move whenever it reclines in relation to the vertical (for example, during operations of the system 100 when the recliner jack 110 is operated to cause recline of the support 112). The lift bracket 906 is formed with a hole that is substantially flush with the rack 108 (from the vertical side, to the right in FIG. 10), in order that the lifter jack 106 can operate in a primarily and substantially vertical direction (for example, during operations of the system 100 when the lifter jack 106 is operated to cause vertical raising and lowering of the support 112).

On the top brace 908, the holder brackets 918 connected to the brace 908 connect to and retain the pivot rod 208. One or more rest stops 920 or the like are connected to bottom brace 904.

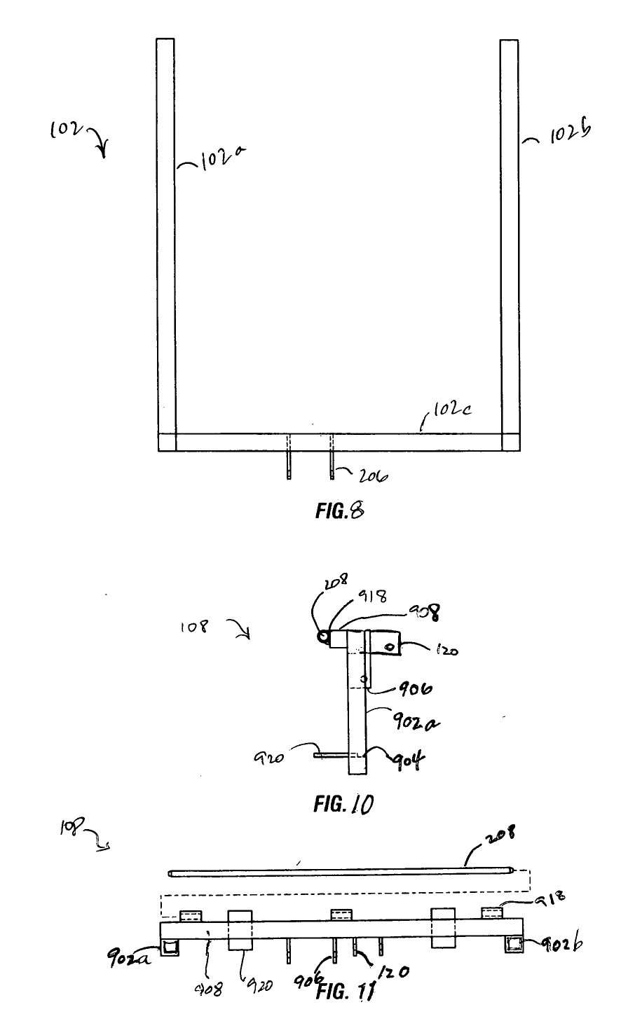

Referring to FIG. 11, the rack 108 has the holder brackets 918 to accommodate the pivot rod 208. The pivot rod 208 is fixedly retained in the holder brackets 918 with a space between the pivot rod 208 and the top brace 908 sufficient to allow the guides 112c of the support 112 to pivot freely when the guides 112c are on the pivot rod 208. The side tubings 902b, 902a of the rack 108 are notable in that each forms a glide channel that accommodates the uprights 102a, 102b of the frame 102, when the rack 108 is located in place on the frame 102 in the system 100.

Referring to FIG. 12, the frame 102 and rack 108 are slidingly connected forming the support assembly 1200 of the system 100 (shown in FIG. 1). In the support assembly 1200, the frame 102 is positioned with the uprights 102a, 102b extending vertically upward from the base 102c. The rack 108 is positioned over the uprights 102a, 102b, such that the side tubings 902a, 902b, respectively, are slidingly engaged with and guided by the uprights 102a, 102b for substantially vertical movement of the rack 108 thereon. The frame 102 is connected to and sits on the wheels 104, via brackets or the like.

The frame base 102c includes the lower lifter bracket 206. The top brace 908 of the rack 108 includes the upper lift bracket 906, corresponding in vertical placement to the lower lift bracket 206. The top brace 908 of the rack 108 also includes the upper recliner bracket 120 (the corresponding lower bracket is the guides 112d of the support 112). The bottom brace 904 of the rack 108 includes the stops 920. The top brace 908 includes the holder brackets 918 and the pivot rod 208 secured therein (shown in phantom) to retain the rack 108 with the support 208 via the pivot rod 208.

In operation, the rack 108 can move vertically up and down along the uprights 102a, 102b. The uprights 102a, 102b retain the rack 108 from lateral movement. The rack 108 is moved vertically by the lifter jack 106 (shown in FIG. 1). The support assembly 1200 is laterally moveable across the floor via the wheels 104.

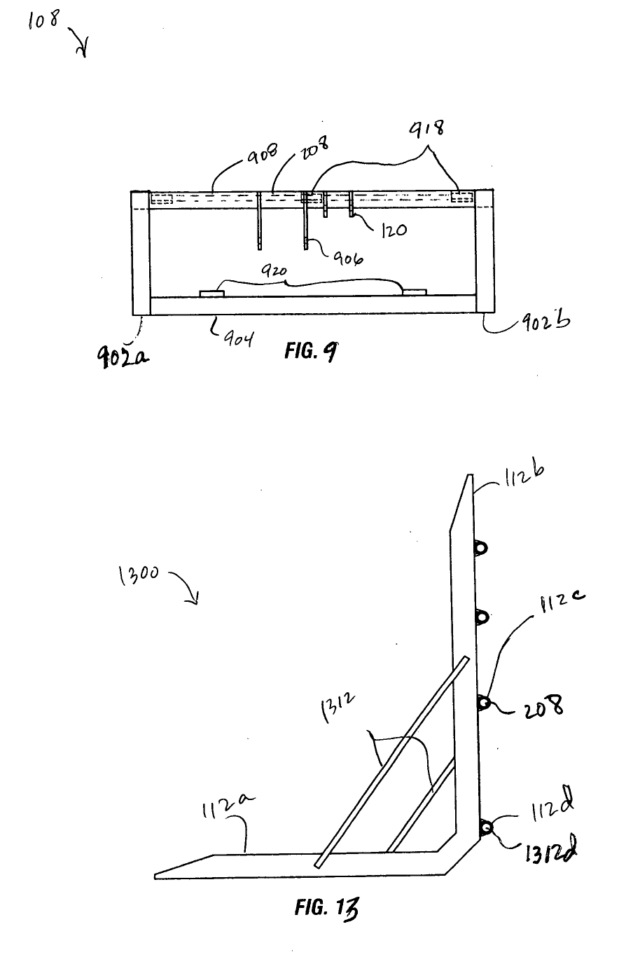

Referring to FIG. 13, the support 112 (shown in FIGS. 1 and 2) of the system 100 (shown in FIGS. 1 and 2) comprises dual ones of a load bearing assembly 1300. Each of the dual ones of the assembly 1300 includes the under arm 112a connected to perpendicular arm 112b. The support 112 is actually comprised of two of the assembly 1300; however, each assembly 1300 of the support 112 is a mirror image piece (i.e., oppositely configured) of the other assembly 1300. In particular, referring to FIG. 12 in conjunction with FIG. 13, the particular one of the assembly 1300 shown in FIG. 13 is attached to the pivot rod 208 of the rack 108, near the side tubing 902a along the top brace 908; a mirror image the assembly 1300 of FIG. 13, is the particular one of the assembly 1300 that is attached to the pivot rod 208 near the side tubing 902b along the top brace 908. Support members 1312 can be connected to the under arm 112a and the perpendicular arm 112b to provide added strength for load bearing by the assembly 1300. The support members 1312 are merely reversed as to front and back (in FIG. 13) of the assembly 1300, for the assembly 1300 that is attached near the side tubing 902b.

Each respective one of the assembly 1300 is attached to the pivot rod 208, in the relative location described, by fitting the pivot rod 208 through one of the guides 112c on the perpendicular arm 112b. The particular guide 112c for the pivot rod 208 is chosen, as appropriate to obtain the desired vertical lift distance that can be obtained for lifting the support 112. Corresponding guides 112c (i.e., same location on the perpendicular arm 112a of each one of the assembly 112) connect to the pivot rod 208. A separate fixed support rod 112d is connected to the perpendicular arm 112b, near the intersection of the perpendicular arm 112b and the under arm 112a of each assembly 1300. The support rod 112d is connected to the lower portion of the recliner jack 110 (shown in FIGS. 1 and 2).

The dual ones of the assembly 1300, in place pivotally connected on the pivot rod 208, and each connected by the lower guide 112d to a lower rod 1312d, form the support 112. The lifting of the support 112 is, of course, performed via the connection of each one of the support assembly 1300 on the pivot rod 208 of the rack 108, and the lifter jack 106 that vertically moves the rack 108 as the rack 108 is guided on the uprights 112a,b of the frame 112. The reclining of the support 112 is, on the other hand, performed via pivotal connection of the lower portion of the recliner jack 110 to the lower rod 1312d at the lower guide 112 and the pivotal connection of each assembly on the pivot rod 208 of the rack 108 at the guide 112c. The recliner jack 110 is pivotally fixed to the top brace of the rack 108, as previously described, and thus the recliner jack 110 extension and contraction operations lean and erect, respectively, the support 112 with relation to the uprights 112a,b of the frame 112 (i.e., with respect to vertical). As previously discussed, the dual ones of the assembly 1300 are freely pivotal on the pivot rod 208 of the rack 108, so that the support 112 can recline via operations of the recliner jack 110.

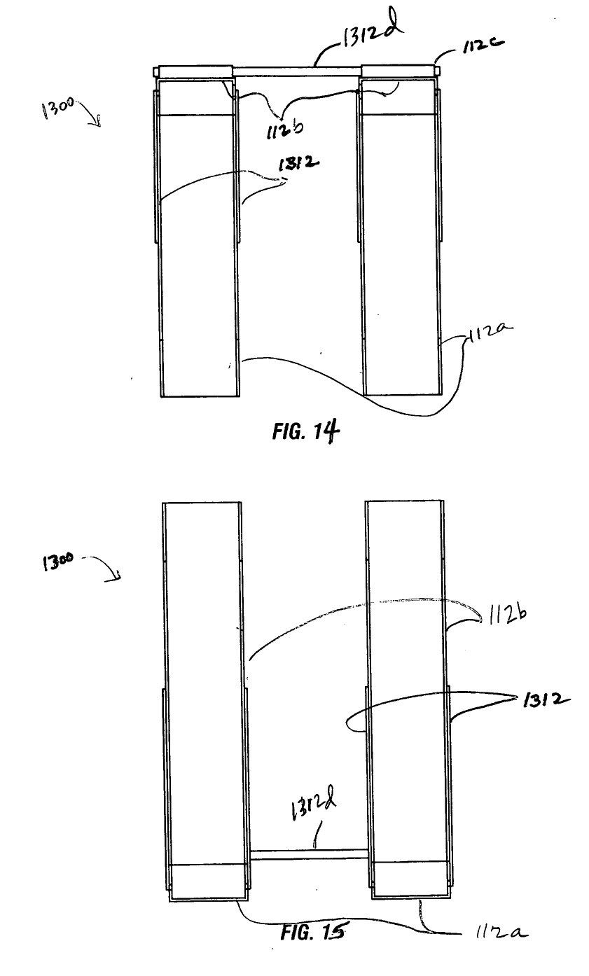

Referring to FIG. 14, the support 112 is viewed from above, where the perpendicular arms 112b are protruding out in the Figure. Thus, the underarms 112a are shown on the upwardly-disposed side, and this side is the channel for loading wheels of a wheelchair or the like onto the support 112. The perpendicular arms 112b provide a back stop for the wheelchair or other item loaded onto the support 112 in operational use of the system 100.

Referring to FIG. 15, the support 112 is viewed as if at the left of FIG. 13 looking to the right towards the outwardly-disposed side of the perpendicular arms 112b. The perpendicular arms 112b can also be channels corresponding to the underarms 112a and for retention or resting stop of the wheelchair or the like loaded on the support 112. The dual assembly 1300 of the support 112 is connected by the support rod 112d. The lower end of the recliner jack 110 pivotally connects, via a bracket of the recliner jack 110, to the rod 112d.

The system 100 is manufactured, generally, of a metal, aluminum, steel, composite or similarly strong material. It is important in the system 100 that the rack 108 ride freely and smoothly up and down along the uprights 102a of the frame 102. It is also important in the system 100 that the support pivot freely and smoothly at the guides 112c connected to the pivot rod 208 and also at the connection to the recliner jack 110 at the bottom end thereof. The recliner jack 110 should freely and smoothly pivot at the connection to the bracket 120 of the rack 108.

The wheels 104 of the system 100 can be multidirectional, including, for example, bearings or other elements, and should provide smooth lateral movement of the entire system 100 over a floor. The frame 102, rack 108, wheels 104, and support 112 assembly of the system must be sufficiently sized and strong to withstand load, lifting and reclining forces whenever the system 100 is loaded with a person in a wheelchair (or other item or load). Additionally, these features must provide quite smooth and easy movement operations, including laterally, vertically, and recline, in order to manipulate the load (such as a wheelchair and person in the wheelchair) in all these directions.

The lift jack 500 (detailed in FIG. 6) of the system 100, one of which is the lifter jack 106 and another of which is the recliner jack 110, can be any gear-driven, screw-driven, pneumatic, manual, winch, electrical, or other mechanism, sufficient to sustain the load on the system 100 via the support 112 when loaded, and to provide easy and smooth lifting and reclining operations to the system 100. A particular lift jack 500 that is useable as both the lifter jack 106 and the recliner jack 110 is a Barker Electric Tongue Jack™ or the like, available from Barker Manufacturing Co. of Battle Creek, Mich. This Barker Electric Tongue Jack™ must be adapted for use in the system 100, however, the motor and gear assembly is workable in the system 100. For example, a 55:1 gear is provided by the motor and gear assembly, and this provides a speed and drive that is acceptable for lift and recline operations of the system. The standard jack has been used, for example, as a leveling jack such as with a recreational vehicle, trailer or the like, therefore, the jack has pods for engaging flat surfaces of the ground and whatever is leveled. This standard jack must be adapted as used in the system 100, including by incorporating an upper guide near the top of the jack and a lower guide near the bottom of the jack—each guide then mates with a bracket of the system 100. In the case of the lifter jack 106, the jack connects via the upper guide to the rack 108 and connects via the lower guide to the frame 102 at the base 102c. For the recliner jack 110, the jack connects via the upper guide to the rack 108 (to a bracket providing clearing for pivot of the recliner jack 110 with respect to the rack 108) and connects via the lower guide to the support rod 112d of the support 112. The extension and contraction of the lifter jack 106 by operations of the jack feature, then raise and lower the rack 108 on the uprights 102a,b. The extension and contraction of the recliner jack 110 by operations of the jack feature, recline and erect the support 112 pivoting on the pivot rod 208 of the rack 108.

The system 100 can be powered, including by electrical motor(s) or other power device or source. Each of the lifter jack 106 and the recliner jack 110 has a separate electrical motor, for example. Although not shown in detail in any of the Figures, a power source must supply the motor(s). The standard Barker jack operates with a 12 Volt power source, that can be supplied by one or more batteries in the system 100. The battery or batteries of the system 100 fit on the system 100 in a non-obtrusive location and placement, for example, on the frame 102, and via wires power the motor(s). Different power sources and different extension/contraction mechanisms are possible in the system 100, as those skilled in the art will know and appreciate. In every event, small size and weight are desirable for the power sources and the mechanisms.

The frame 102 of the system 100 can be differently shaped, for example, with more or less sides/extensions as the base 102c, the uprights 102a,b or otherwise. Also, the frame 102 could be tubular, I-beam, or other strong lengths or pieces. Additional or fewer, and hard, soft, inflated, bearing, or other, wheels can be employed in the system 100, with smooth and multi-directional lateral movement being an objective. The uprights 102a,b of the frame 102 should provide smooth surfaces for gliding of the rack 108 thereon, and the rack 108 and uprights 102a,b as slidingly connected provide a smooth up and down movement, with or without load. A friction reducing grease, graphite, bearings, surfaces, coatings, or other materials or elements can be employed in the uprights 102a,b and the rack 108 in order to provide continuously smooth and easy lifting and lowering of the rack 108.

Likewise, the support 112 of the system 100 can be differently shaped or designed, for example, as a flat continuous planar piece, a seat or fixture, a gripping mechanism that retains an item as loaded, and others. It is desirable that the support 112 provide easy loading of an item, for example, a wheelchair with a person in the wheelchair, by rolling the item onto the support 112 or otherwise. Also, the support 112 must freely and smoothly pivot with respect to the frame 102, in order to provide easy and smooth recline operations to the support 112. Friction reducing materials, compositions, surfaces and the like can be employed to provide continuously smooth and easy recline/erect operations of the support 112.

Various other uses and operations of the system 100 are possible. The system 100, either adapted or as described, can be employed to maneuver most any load. The support 112 of the system 100 described above, and the various other features, are particularly useful in assisting to maneuver a wheelchair and person in the wheelchair. The wheelchair with person is rolled onto the support 112, when the underarms 112a of the support 112 are positioned substantially flush with the floor. The support 112 is raised and lowered via the lifter jack 106 operations, as desired and whether or not the support is loaded. The support is reclined and erected via the recliner jack 110 operations, also as desired and whether or not the support is loaded. This operation permits lifting of a person in a wheelchair and also reclining of the person in the wheelchair, as well as lateral multi-directional movement of the person in the wheelchair on the support. The system 100 can accommodate other items and loads, including equipment, bagged or bundled materials, devices, and so forth. As so employed, the system 100 can assist in maneuvering those items and loads in lifting, lateral multi-direction shifting, and reclining. The system 100 can be employed for such assistance in maneuvering in a wide variety of environments, including, for example, beauty shops or salons, medical offices or hospitals, dental offices, home or other access limited locations, and otherwise generally any environment in which assistance (preferable, for lateral, vertical and recline movements) is desired or possible.

The system 100 can include added or fewer features, and also can include various convenience and safety elements. For example, a centralized control panel could be provided for switching on/off the lifter jack 106 and recliner jack 110, respectively. A single motor could power both the lifter jack 106 and recliner jack 110, with applicable gearing and other features to perform these operations. Any battery or other power source can be a renewable or rechargeable source, or the source can be AC power or other source if appropriate parts are included. The lifting and reclining operations can be variable speed, via power regulation or similar mechanisms. Additional maneuverability features, for example, a drive for wheels of the system 100 for lateral movement or other, are possible. Safety features for the system 100 can include restraints, straps, lock mechanisms, non-skid surfaces, hooks, fail-safe power elements, and other matters.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for assisting maneuvering, comprising:
a frame;
a wheel connected to the frame;
a rack formed to glide on the frame; and
a support connected to the rack.

2. The system of claim 1, wherein the support is formed to accommodate wheels of a wheelchair.

3. The system of claim 1, further comprising:
a mechanized lifter, connected to the rack and the frame;
wherein the lifter selectively vertically raises and lowers the rack along the frame; and
wherein the support vertically raises and lowers according to movement of the rack, as the rack is respectively raised and lowered.

4. A system for assisting maneuvering, comprising:
a frame;
a wheel connected to the frame; and
a support pivotally connected to the frame.

5. The system of claim 4, wherein the support is formed to accommodate wheels of a wheelchair.

6. The system of claim 4, further comprising:
a mechanized recliner, connected to the frame and the support;
wherein the recliner selectively tilts forward and backwards the support relative the frame.

7. A system for manipulating a load, comprising:
a load support;
a jack connected to the support, for vertically moving the support and for reclining the support.

8. The system of claim 7, further comprising:
a roller connected to the support, for laterally moving the support.

9. The system of claim 7, wherein the load support accommodates and can retain a wheelchair and the jack smoothly lifts and reclines the load support when loaded with the wheelchair and a person in the wheelchair.

10. The system of claim 7, wherein the jack comprises a first jack for vertically moving the support and a second jack for reclining the support.

11. The system of claim 10, further comprising a battery, wherein the first jack and the second jack are each powered by the battery.

12. The system of claim 10, further comprising at least one switch for selectively turning on and off the first jack and the second jack.

13. A method of assisting maneuverability of a person in a wheelchair, comprising the steps of:
lifting the wheelchair and the person in the wheelchair; and
reclining the wheelchair and the person in the wheelchair.

14. The method of claim 13, further comprising the step of:
loading the wheelchair and the person in the wheelchair onto a device capable of lifting and reclining.

15. The method of claim 14, further comprising the step of rolling the device, together with the wheelchair and the person in the wheelchair, after the step of loading.

16. The method of claim 15, wherein the steps of lifting, reclining and rolling are each independently selectively performed.

17. A method of assisting a load, comprising the steps of:
supporting the load via a support;
rolling the support;
lifting the support; and
reclining the support;
wherein the steps of rolling, lifting and reclining manipulate the load to roll, lift and recline.

18. The method of claim 17, wherein the load is a wheelchair.

19. The method of claim 18, further comprising the step of:
selectively performing the steps of rolling, lifting and reclining.

20. A system for lifting assistance, comprising:
a frame;
a support; and
a lifter connected to the frame and the support.

21. A system for reclining assistance, comprising:
a frame;
a support; and
a recliner connected to the frame and the support.
